(19) United States
(12) Patent Application Publication
(10) Pub. No.: US 2015/0376918 A1
(43) Pub. Date: Dec. 31, 2015

(54) VEHICLE DOOR LATCH DEVICE

(71) Applicant: MITSUI KINZOKU ACT CORPORATION, Yokohama-shi, Kanagawa (JP)

(72) Inventors: Tomoharu Nagaoka, Yokohama (JP); Hideaki Nozawa, Yokohama (JP)

(73) Assignee: Mitsui Kinzoku Act Corporation, Yokohama-shi (JP)

(21) Appl. No.: 14/768,168

(22) PCT Filed: Sep. 3, 2014
(86) PCT No.: PCT/JP2014/073169

§ 371 Date: Aug. 14, 2015

(30) Foreign Application Priority Data
Jan. 24, 2014 (JP) 2014-010904

(51) Int. Cl. E05B 79/10; E05B 85/24

(52) U.S. Cl. CPC E05B 79/10; E05B 85/243

(57) ABSTRACT

A vehicle door latch device comprises an engagement assembly comprising an engagement mechanism which is engagable with a striker of a vehicle body; a first casing which can be connected from one direction to an operating mechanism which can turn to a locking state and an unlocking state; an operating assembly comprising a second casing to which the engagement assembly is attached; an outside lever pivotally supported on the engagement assembly; and positioning-guide means by which the engagement assembly can be connected from the same direction as a direction in which the operating mechanism is connected to the first casing, thereby improving assembling efficiency and getting smaller.

### CROSS REFERENCE TO RELATED APPLICATIONS

This is the U.S. National Stage of International Application No. PCT/JP2014/073169, filed Sep. 3, 2014, which in turn claims the benefit of and priority to Japanese Patent Application No. JP2014-10904, filed Jan. 24, 2014.

### BACKGROUND OF THE INVENTION

The present invention relates to a vehicle door latch device.

A vehicle door latch device comprises a synthetic-resin body fixed to a door; an engagement assembly stored in the body and comprising an engagement mechanism, such as a latch engagable with a striker of a vehicle body and a pawl engagable with the latch; and a synthetic-resin casing fixed to the back of the body; and an operating assembly connected in the casing to turn a door to a locking state and an unlocking state in JP4765123B2 and JP2012-233318A.

The door latch devices in JP4765123B2 and JP2012-233318A provide an advantage for easy assembling in which the engagement mechanism such as the latch and pawl is connected to the body, and the engagement assembly that comprises the engagement mechanism is connected to the operating assembly, so that the door latch device can easily be assembled, which is advantageous.

However, in the door latch devices, an outside lever that moves with an outside handle on the door is supported via a pivot shaft which lies longitudinally of the vehicle on the casing and the following problem is involved.

Recently, automatic assembling has been carried out so as to improve assembling efficiency of door latch devices. As mentioned above, the outside lever is supported via a pivot shaft which lies longitudinally of the vehicle, on the casing. Hence, there are two directions perpendicular to each other, comprising a direction for connecting the operating mechanism to the casing and a direction for connecting the outside lever, and it is not possible to connect in the automatic assembling line from the same direction. Thus, conventionally, it was necessary to connect the outside lever to the casing in another step. In order that the operating mechanism and the outside lever are connected from the same direction, it was necessary to turn a direction of the casing by 90 degrees in an assembling line, thereby increasing the number of steps when the door latch devices were assembled, decreasing assembling efficiency and increasing the assembling cost.

In both of the door latch devices in JP4765123B2 and JP2012-233318A, the pivot shaft and the outside lever supported thereby are located below the engagement assembly of the casing. When the engagement assembly is connected, the pivot shaft is not contacted with the outside lever. The height of the casing increases by the part in which the pivot shaft and outside lever are located below the engagement assembly, so that the whole door latch device which includes the casing gets larger, which is disadvantageous.

Furthermore, in both of the door latch devices in JP4765123B2 and JP2012-233318A, the engagement assembly is connected to the operating assembly in a stationary state. Thus, it was necessary to connect the casing to the engagement assembly by fixing means such as screws from a direction different from the connecting direction of the operating mechanism, thereby requiring fixing operation and decreasing assembling efficiency, which is disadvantageous.

### SUMMARY OF THE INVENTION

In view of the disadvantages, it is an object of the invention to provide a vehicle door latch device that improves assembling efficiency and becomes smaller.

### BRIEF DESCRIPTION OF THE DRAWINGS

FIG. 1 is a perspective view of a door latch device according to the present invention in which a cover is partially cut away.

FIG. 2 is a front elevational view of the door latch device viewed from the back of the vehicle.

FIG. 3 is a side elevational view of the door latch device viewed from the inside of the vehicle when the cover is removed.

FIG. 4 is an exploded perspective view before an operating mechanism and an engagement assembly are connected to a casing.

FIG. 5 is an enlarged vertical sectional view taken along the line V-V in FIG. 1.

FIG. 6 is an enlarged horizontal sectional view taken along the line VI-VI in FIG. 3.

FIG. 7 is an exploded perspective view of the engagement assembly.

FIG. 8 is a front elevational view of the engagement assembly viewed from the back of the vehicle.

FIG. 9 is a back elevational view of the engagement assembly viewed from the front of the vehicle.

FIG. 10 is a perspective view of the engagement assembly viewed from the front obliquely of the vehicle.

FIG. 11 is a perspective view of the relation of the back member and the second casing viewed from the back obliquely of the vehicle.

### DETAILED DESCRIPTION OF PREFERRED EMBODIMENTS

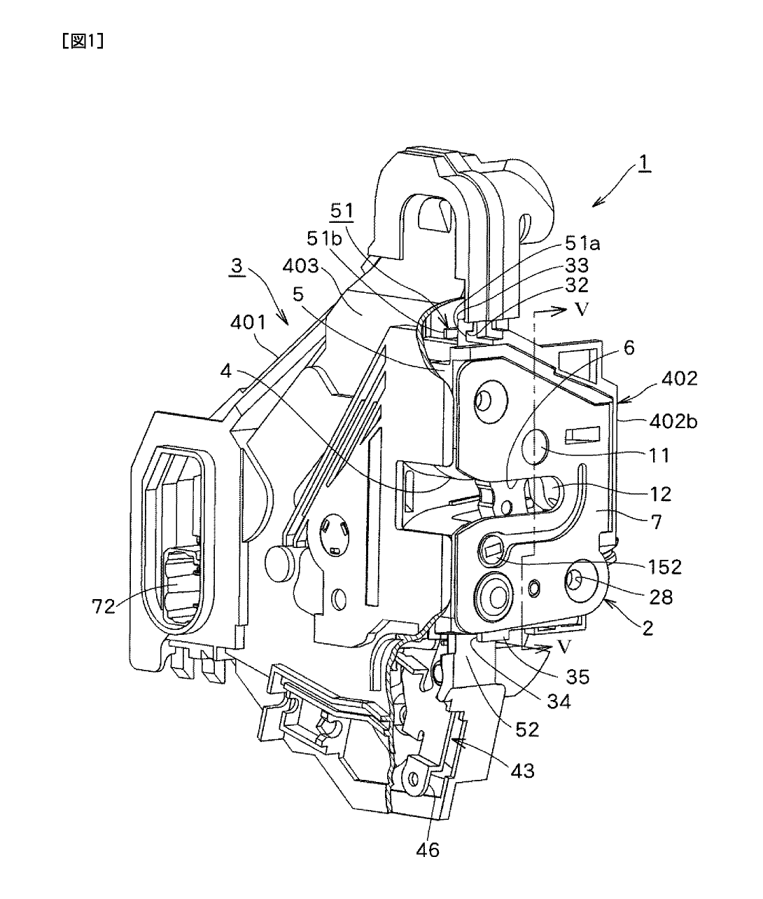

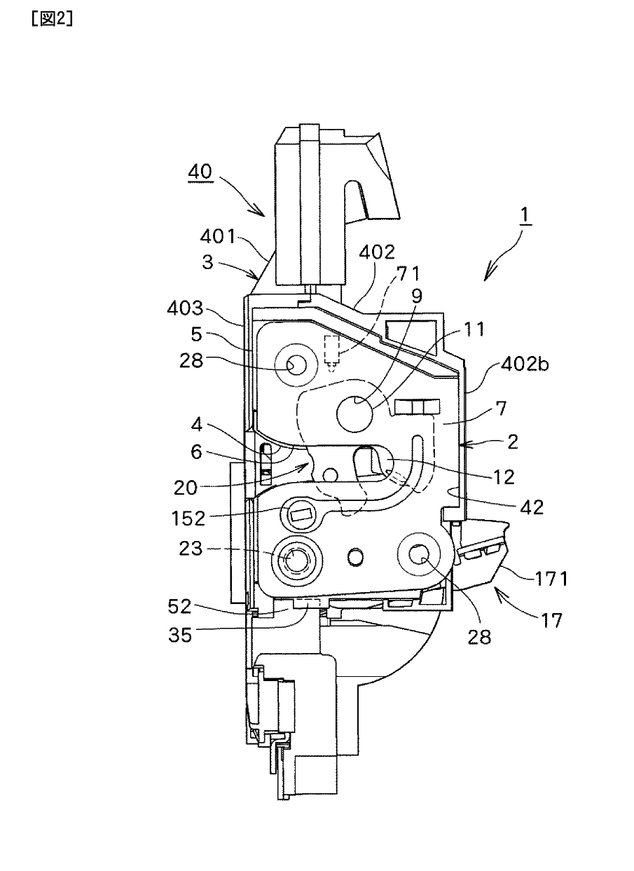

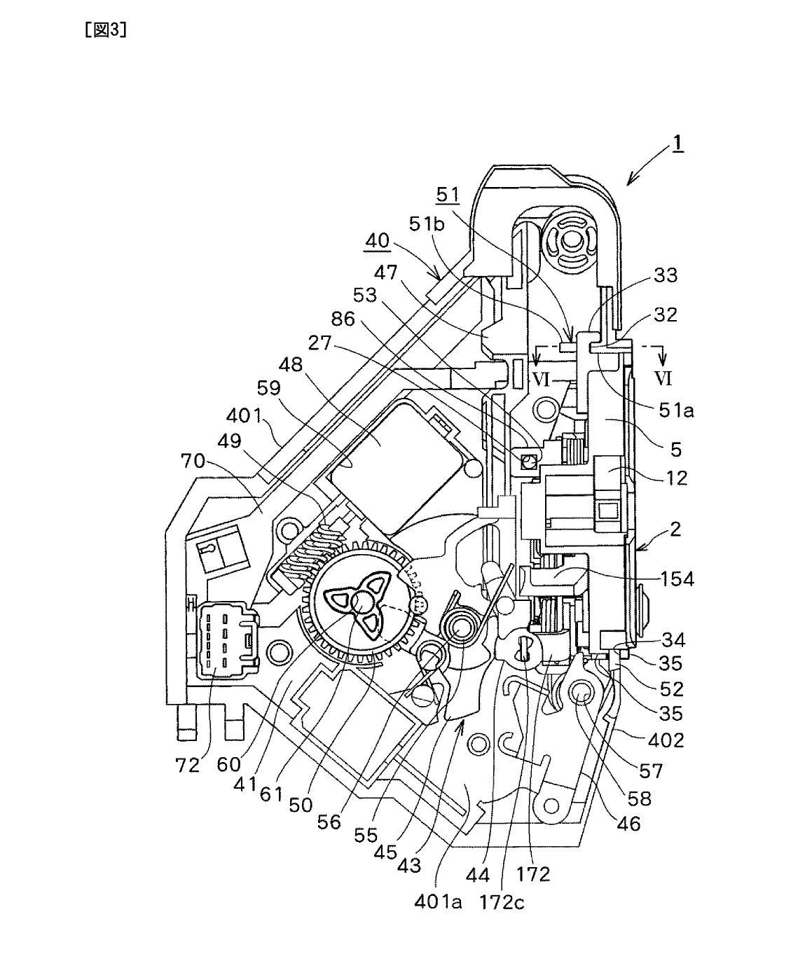

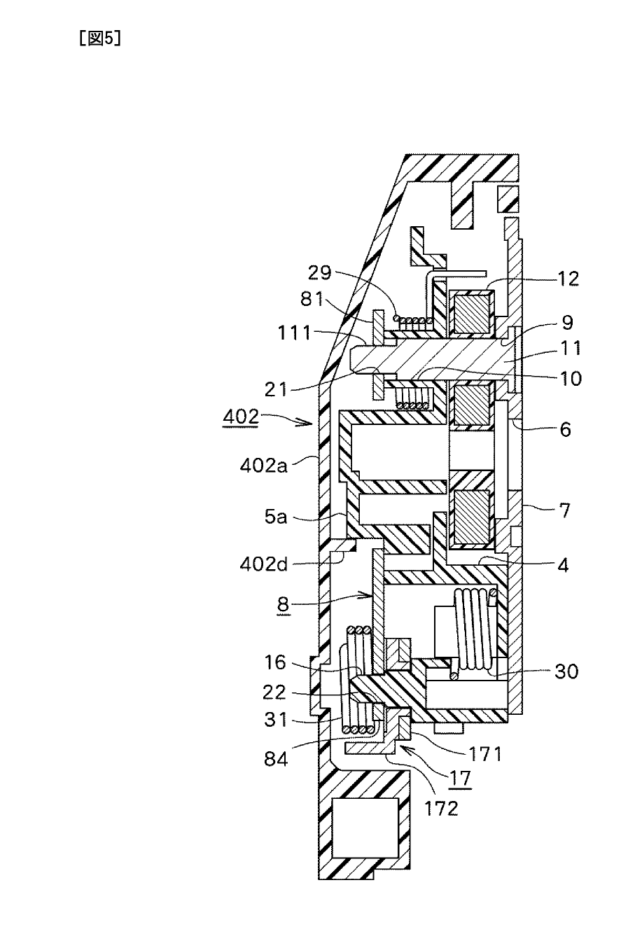

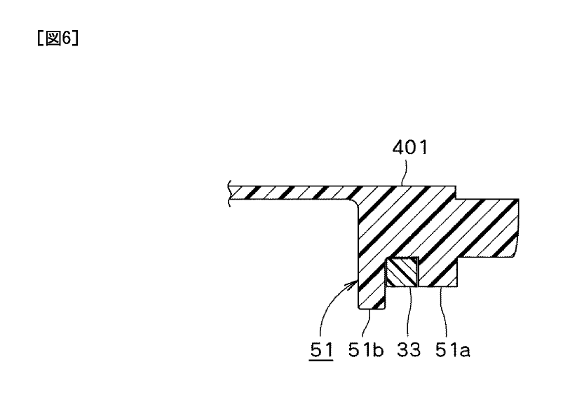

One embodiment of a door latch device according to the present invention will be described with FIGS. 1 to 11. In the following description, the left and right in FIG. 2 are deemed “inside” and “outside” of the vehicle respectively. The left and right in FIG. 3 are deemed “front” and “back” of the vehicle respectively.

A door latch device 1 in this embodiment is mounted to the rear end of a front side door (hereinafter called “door”) of a car, and comprises an engagement assembly 2 which engages with a striker S of a vehicle body to hold the door closed and an operating assembly 3 for operating the engagement assembly 2.

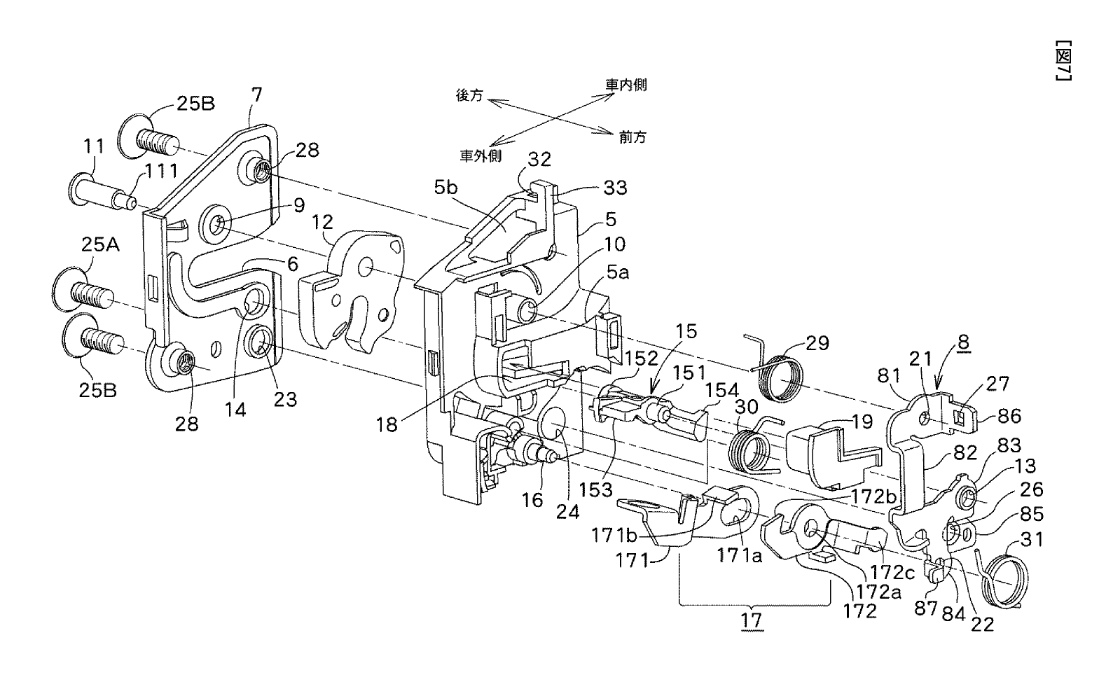

In FIG. 7, the engagement assembly 2 comprises a synthetic-resin body 5 which has a striker-entering groove 4 into which a striker S comes; a metal cover member 7 which is fixed to the back side of the body 5 and has a cut-out portion 6 into which the striker S comes; a metal back member 8 fixed to the front side of the body 4; a latch 12 held in the body 4 close to the back side and pivotally mounted via a latch shaft 11 which passes through an axial hole 9 of the cover member 7 and an axial hole 10 of the body 5, the latch 12 being engagable with the striker S of a vehicle body; a pawl 15 attached in the body 5 and comprising an engaging portion 153 which can engage with the latch 12 which engages with the striker S and a releasing portion 154 which a releasing member 44 (later described) of the operating assembly 3 can contact, a front axial portion 151 being pivotally mounted in an axial hole 13 of the back member 8, a rear axial portion 152 being pivotally mounted in an axial hole 14 of the cover member 7; an outside lever 17 pivotally mounted vertically via a pivot shaft 16 fixed to the body 5 in parallel with the latch shaft 11; and a bumper rubber 19 made of elastic member such as rubber disposed in a bumper-rubber hole 18 in the body 5. The latch 12 and the pawl 15 correspond to an engagement mechanism 20 in this invention.

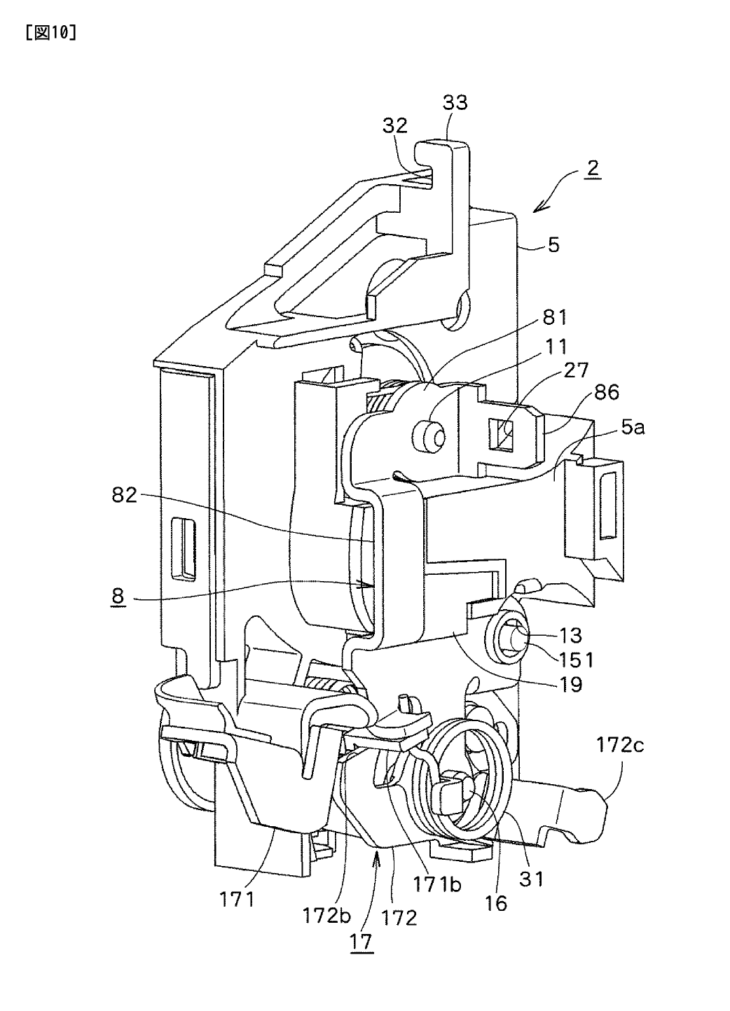

The back member 8 comprises a first axial-hole forming portion 81 which has an axial hole 21 in which a smaller-diameter axial portion 111 at the end of the latch shaft 11 pressingly fits not to rotate; a U-shaped holding portion 82 (FIG. 10) which extends downward from the end of the first axial-hole forming portion 81 close to the outside of the vehicle and which can hold a projection 5a on the front surface of the body 5 and part of the bumper rubber 19; a second axial-hole forming portion 83 which extends toward the inside of the vehicle from the lower end of the holding portion 82 and has the axial hole 13 in which the axial portion 151 of the pawl 15 rotatably fits; a support-hole forming portion 84 which extends downward from the middle of the second axial-hole forming portion 83 and has a support hole 22 in which the pivot shaft 16 of the body 5 fits; a screw-hole forming portion 85 which has a screw hole 26 in which a bolt 25A engages, the bolt 25A passing through a hole (not shown) of an inner panel of the door, a though hole 23 of the cover member 7 and a through hole 24 of the body 5; and a guide-hole forming portion 86 which extends forward from the end of the first axial-hole forming portion 81 close to the inside of the vehicle and has a guide hole 27 in which a third guide portion 53 (later described) of the operating assembly 3 engages.

The engagement assembly 2 is fixed with the operating assembly 3 on the inner panel of the door with the bolt 25A and two bolts 25B, 25B which engage in screw holes 28, 28 of the cover member 7. The bolt 25A engages in the screw hole 26 of the back member 5, and the back member 8 is fixed on the back surface of the body 5.

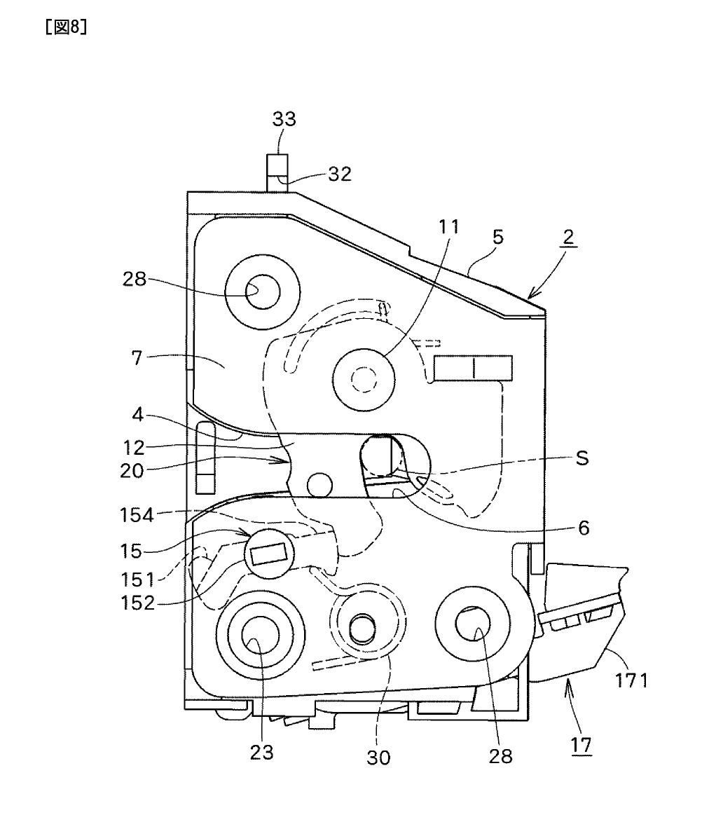

The latch 12 is urged in a door-opening direction (clockwise in FIG. 8) by a spring 29 in which one end engages with the front surface of the body 5 and the other end engages with the latch 12. The pawl 15 is urged in the direction that it engages with the latch 12 (counterclockwise in FIG. 8) by a spring 30 in which one end engages with the body 6 and the other end engages with the pawl 15.

On the upper surface of the body 5 close to the inside of the vehicle, a first guided portion 33 which has a U-shaped guide groove 32 which is open backward, inward and outward of the vehicle projects upward. In FIGS. 1 to 3, on the lower surface of the body 5 close to the inside of the vehicle, a pair of second guided portions 35, 35 which has a guide groove 34 which is open downward, inward and outward of the vehicle projects downward. The first guide portion 51 and the second guide portion 52 of the casing 40 (later described) fit in the first guided portion 33 and the second guided portions 35, 35 respectively.

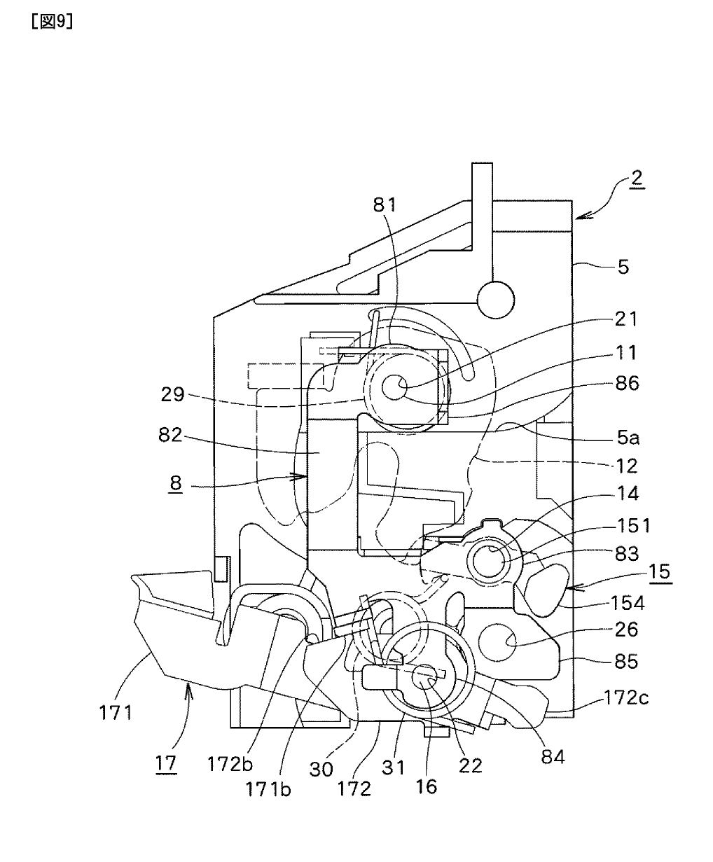

The outside lever 17 comprises two separatable structures that are a first lever 171 which has an elongate hole 171a in which the pivot shaft 16 fits rotatably and movably along width of the vehicle; and a second lever 172 disposed on the front face of the first lever 171 and having an axial hole 172a in which the pivot shaft 16 rotatably fits. The lower surface of a forward engaging portion 171 bent from the upper edge of the first lever 171 comes in contact with an upper end 172b of the second lever 172, so that the first lever 171 and second lever 172 move together from a standby position in FIGS. 8 and 9 in a releasing direction (clockwise in FIG. 8) The first lever 171 and the second lever 172 are urged counterclockwise in FIG. 8 by a spring 31 in which one end engages with the first lever 171 and the other end engages with the second lever 172.

The end of the first lever 171 close to the outside of the vehicle is connected to an outside handle (not shown) on an outer panel of the door via a motion transmitting member (not shown) such as a rod. When the outside handle is actuated to open the door, the pawl 15 is rotated in a releasing direction via a releasing member 44 (later described) of the operating assembly 3 connected to the end 172c of the second lever 172 close to the inside of the vehicle.

If the outer panel of the door is deformed by side collision inward of the vehicle and contacted with the first lever 171, the first lever 171 is moved inward of the vehicle via the elongate hole 171a, thereby separating the forward engagement portion 171b of the first lever 171 from the upper end 172b of the second lever 172. Thus, even if the first lever 171 turns in a releasing direction, the turning motion is not transmitted to the second lever 172, thereby preventing the second lever 172 and the releasing member 44 connected to the end 172c from moving in a releasing direction. Hence, the pawl 15 is prevented from turning in a releasing direction, so that the door is not opened unexpectedly by side collision.

In FIGS. 1 to 4, the operating assembly 3 comprises am approximately L-shaped casing 40 made of synthetic resin. The casing 40 comprises a first casing 401 disposed close to the side of the inner panel in the door and having an operating mechanism holding portion 41 which is open inward of the vehicle; a second casing 402 which extends at approximately right angles from the rear end of the middle of the first casing 401 and has an engagement-assembly holding portion 42 continuous with the operating-mechanism holding portion 41; a synthetic-resin cover 403 which covers an opening of the first casing 401 and second casing 402; and an operating mechanism 43 connected from one direction or a vehicle-inward direction into the operating-mechanism holding portion 41 of the first casing 401.

The second casing 402 comprises a base portion 402a which covers the front face of the engagement assembly 2 when the engagement assembly 2 is connected to the operating assembly 3; and a side wall 402b which covers the upper surface and the side of the engagement assembly 2.

At the upper end of the first casing 401 close to the second casing 402, the first guide portion 51 with which the first guided portion 33 of the body 4 can engage from the inside of the vehicle is integrally formed. (in FIGS. 1 and 3) The first guide portion 51 comprises a rear guide projection 51a which projects forward and inward of the vehicle and can fit in a guide groove 32 of the first guided portion 33; and a front guide projection 51b which is spaced forward from the rear guide projection 51a to project inward of the vehicle and to limit forward movement of the first guided portion 33. At the lower end of the second casing 402 close to the inside of the vehicle, the second guide portion 52 which can fit from the inside of the vehicle in the guide groove 34 of the second guided portions 35, 35 is a little spaced backward from the rear surface of the base portion 402a and projects upward (in FIGS. 1 to 4).

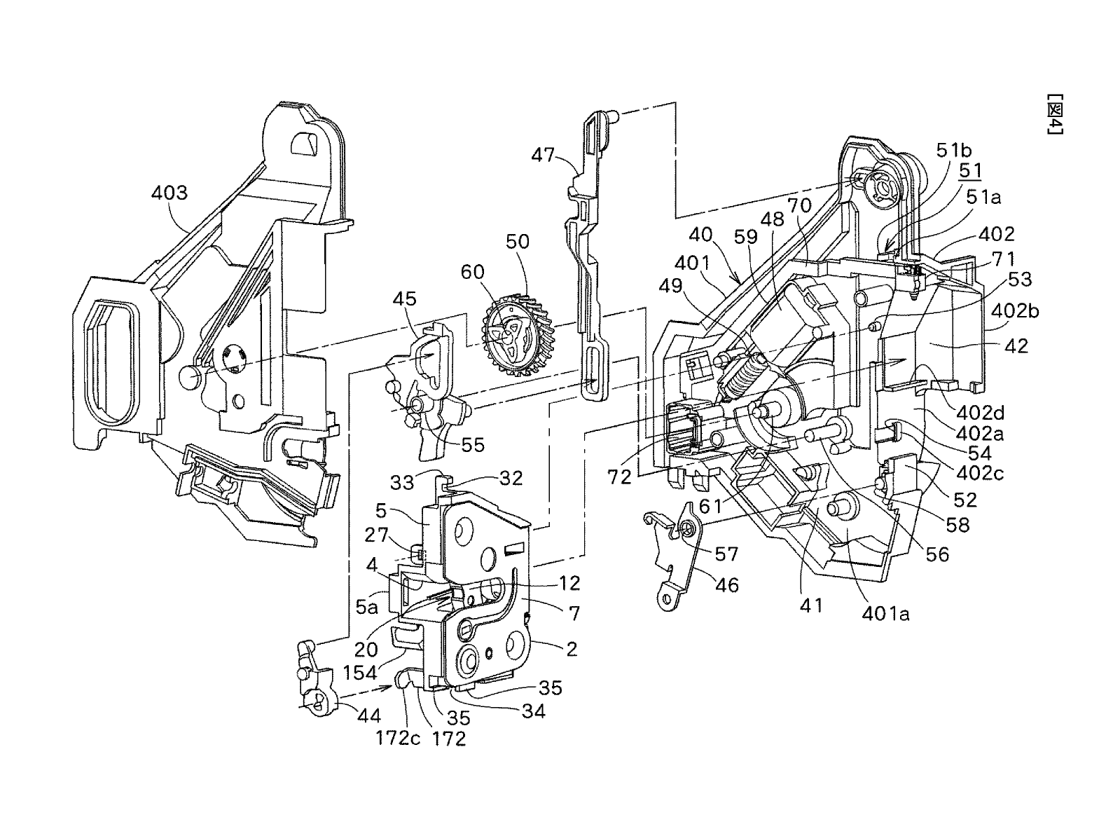

Furthermore, in FIGS. 3 and 4, in the middle of a border of the base portion 402 of the second casing 402 with the first casing 401, a third guide portion 53 which fits in the guide hole 27 of the back member 8 projects toward the inside of the vehicle.

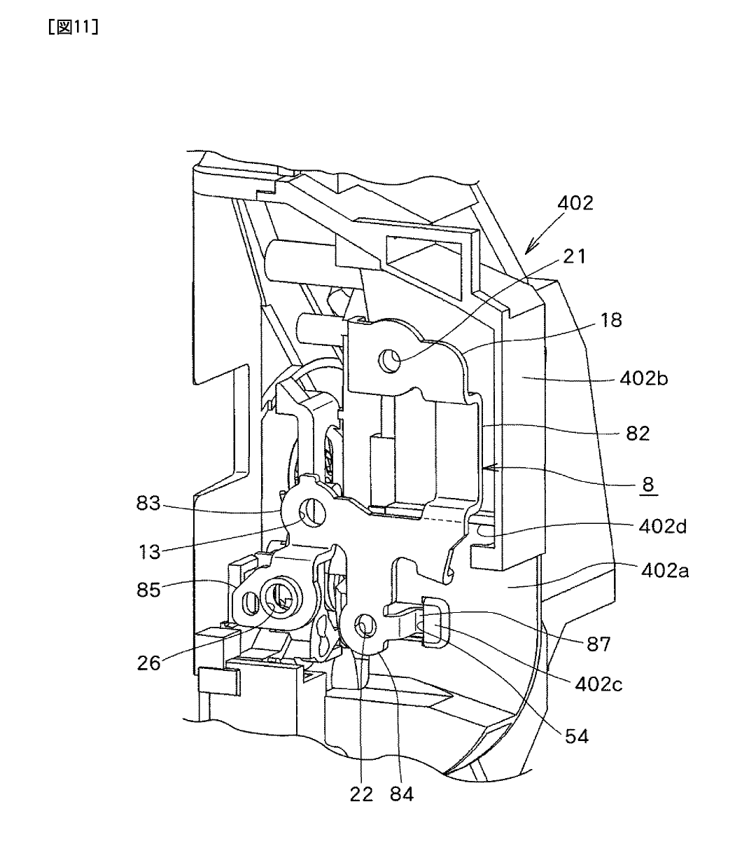

In FIGS. 4 and 11, a projection 402c is formed on the back side of the base portion 402a of the second casing 402. A fourth guide portion 54 which is open toward the inside of the vehicle like a groove is formed between the projection 402c and the back surface of the base portion 402a. When the engagement assembly 26 is connected to the second casing 402, a fourth guided portion 87 which bends from a support-hole forming portion 84 of the back member 8 and extends toward the outside of the vehicle can be fitted into the fourth guide portion 54 from the direction of the inside of the vehicle. Any one of the first guided portion 33 with the first guide portion 51 which engage each other, the second guided portion 35 with the second guide portion 52, the guide hole 27 with the third guide portion 53 and the fourth guided portion 87 with the fourth guide portion 54 corresponds to positioning-guide means in this invention.

In FIGS. 4, 5 and 11, a substantially horizontal guide portion 402d projects backward from the middle of the base portion 402a of the second casing 402. In order to connect the engagement assembly 2 to the second casing 402, the guide portion 402d comes in sliding contact with the projection 5a of the body 5 of the engagement assembly 2 and with the holding portion 82 of the back member 8 for holding the projection 5a. Hence, the engagement assembly 2 is vertically positioned and is guided to slide toward the second casing 402.

In an unlocking state, the operating mechanism 43 makes the latch 12 disengage from the striker S to enable the door to open with opening operation of the outside handle and inside handle of the door, and in a locking state, does not enable the door to open even by opening operation of the outside handle and inside handle.

In FIGS. 3 and 4, the operating mechanism 43 mainly comprises the releasing member 44 which is coupled to the end 172c of the second lever 172 of the outside lever 17; a locking lever 45 connected to the releasing lever 44 and a locking knob (not shown) on the door inside the vehicle to enable the releasing member 44 to shift to a locking position for disabling the pawl 15 to turn or to an unlocking position for enabling the pawl 15 to turn; an inside lever 46 which enables the door to open with the inside handle for opening the door on the door inside the vehicle; a sliding lever 47 which enables the locking lever 45 to turn to a locking position or an unlocking position with a key cylinder (not shown) on the outer panel of the door; a motor 48 which is reversible for locking an unlocking; and a worm wheel 50 which enables the locking lever 45 to shift to a locking position and an unlocking position.

The locking lever 45 is installed in the operating-mechanism holding portion 41 of the first casing 401 by fitting, from a direction of the inside of the vehicle, a bush 55 on around a support shaft 56 which projects from the side of the base portion 401 a of the first casing 401. The bush 55 lies transversely of width of the vehicle. The inside lever 46 is installed in the operating-mechanism holding portion 41 from the direction of the inside of the vehicle by fitting an axial hole 57 on around a support shaft 58 which projects from the side of the base portion 401a and extends toward the inside of the vehicle. The sliding lever 47 is installed in the operating-mechanism holding portion 41 from a direction of the inside of the vehicle.

The motor 48 is installed in a motor holding portion 59 which is open in a direction of the inside of the vehicle and is formed on the side of the base portion 401a, from a direction of the inside of the vehicle. The worm wheel 50 is installed in the operating-mechanism holding portion 41 by fitting a central axial hole 60 on around a support shaft 61 which projects from the middle of the base portion 401a toward the inside of the vehicle.

In FIG. 4, a switch plate 70 is fixed in the operating-mechanism holding portion 41 by connecting a connector 72 to the motor 48 and a latch switch 71 for detecting a position of the latch 12.

Then, it will be described to put the engagement assembly 2 together with the operating assembly 3.

Before putting the engagement assembly 2 together with the operating assembly 3, the outside lever 17, the engagement mechanism 20 which comprises the latch 12 and pawl 15, the bumper rubber 19, the springs 29, 30, 31, the cover member 7 and the back member 8 are formerly connected to the body 5 of the engagement assembly 2 to form the engagement assembly 2.

Then, the casing 40 of the operating assembly 3 is set on an automatic assembling line, for example, such that the operating-mechanism holding portion 41 of the first casing 401 (at the inside of the vehicle) faces above. In FIG. 4, (in FIG. 4, the operating-mechanism holding portion 41 of the first casing 401 faces the left), the assembled engagement assembly 2 is stored in the engagement-assembly holding portion 42 by sliding the engagement assembly 2 along the base portion 402a of the second casing 402 from the direction of the operating-mechanism holding portion 41 of the first casing 401 or from a vehicle-inside direction. As mentioned above, sliding of the engagement assembly 2 is guided with the guide portion 402d of the base portion 402a of the second casing 402, and the engagement assembly 2 is positioned with respect to the second casing 402.

When the engagement assembly 2 is put in the engagement-assembly holding portion 42, a plurality of positioning-guide means of the engagement assembly 2 is fitted with a plurality of positioning-guide means of the first casing 401 and second casing 402, such as, the first guided portion 33 with the first guide portion 51; the second guided portion 35 with the second guide portion 52; the guide hole 27 with the third guide portion 53; and the fourth guided portion 87 with the fourth guide portion 54. The engagement can all be carried out in the same direction as an assembling direction of the engagement assembly 2 from the operating-mechanism holding portion 41 of the first casing 401 or from a direction of the inside of the vehicle. Before the engagement assembly 2 is held in the engagement-assembly holding portion 42, the switch plate 70 is fixed to the operating-mechanism holding portion 41 of the first casing 401, enabling the latch switch 71 to be set up when the engagement assembly 2 is put in the engagement-assembly holding portion 42. Specifically, the end of the switch plate 70 to which the latch switch 71 is attached projects into the engagement-assembly holding portion 42 and the latch switch 71 comes in the latch-switch holding portion 5b of the body 5. Hence, the latch switch 71 is positioned within a turning path of the latch 12, enabling the latch 12 to be detected in position in FIG. 2.

When the engagement assembly 2 is installed in the engagement-assembly holding portion 42, a plurality of positioning-guide means is fitted on each other, and the engagement assembly 2 is connected to the second casing 402. After connection of the engagement assembly 2, the engagement assembly 2 is positioned such that it is prevented from moving longitudinally, transversely and vertically of the vehicle with respect to the second casing 402. At the same time, high separation resistance is provided against longitudinal separating load (or load in a direction of separating the engagement assembly 2 backward to the casing 40) acting between the engagement assembly 2 and the second casing 402. Thus, it becomes unnecessary to fix the engagement assembly 2 to the second casing 402 with fixing means such as a screw. A side wall 402b of the second casing 402 is provided only over an upper half of the base portion 402a, preventing the first lever 171 of the outside lever 17 from contacting the side wall 402b of the first lever 171. The end of the first lever 171 projects from the second casing 402 toward the outside of the vehicle

After the engagement assembly 2 is connected to the second casing 402, the releasing member 44, locking lever 45, inside lever 46, sliding lever 47, motor 48 and worm wheel 50 of the operating mechanism 43 is connected from the direction of the inside of the vehicle as well as the engagement assembly 2 into the operating-mechanism holding portion 41 of the first casing 401.

Finally, the cover 403 is mounted over an vehicle-inside opening of the first casing 401, and the operating mechanism 43 stored in the operating-mechanism holding portion 41 and the side of the body 5 of the engagement assembly 2 are covered with the cover 403 except the striker-entering groove 4 in FIG. 1. Thus, assembling is completed and the door latch device 1 that comprises the engagement assembly 2 and operating assembly 3 is obtained. The cover 403 can be fixed over the first casing 40 by ultrasonic wave or lazar other than a screw.

As mentioned above, in the door latch device 1 in the embodiment, the outside lever 17 is mounted to the engagement assembly 2, and a plurality of positioning-guide means for positioning the engagement assembly 2 with respect to the second casing 402 and guiding from the same direction as a direction for connecting the operating mechanism 43 to the first casing 401 is provided. Thus, the operating mechanism 43 and engagement assembly 2 are connected to the first casing 401 and the second casing 402 respectively from the same direction or from a direction of the inside of the vehicle. It becomes unnecessary to connect the outside lever 17 to the second casing 402 as another step or turning a direction of the casing 40 at right angles in an automatic assembling line thereby improving assembling efficiency of the door latch device 1 and cutting down the cost.

The outside lever 17 is connected in the body 4 of the engagement assembly 2. Thus, it becomes unnecessary to provide a pivot shaft for supporting the outside lever 17 to the second casing 402. The pivot shaft and the outside lever 17 are not hindrance when the engagement assembly is connected to the second casing 402. It is not necessary to increase height of the second casing 402 for the pivot shaft and outside lever 17 thereby enabling the whole door latch device with the casing 40 to get smaller.

The side of the body 5 of the engagement assembly 2 toward the inside of the vehicle is held by the cover 403 fixed to the first casing 401 in FIG. 1, thereby preventing the engagement assembly 2 from moving toward the inside of the vehicle opposite a connecting direction. It is not necessary to fix the second casing 402 and engagement assembly 2 with fixing means such as a screw from a direction different from the connecting direction of the operating mechanism 43, thereby improving assembling efficiency of the door latch device.

The embodiment of the present invention is described and the following variations and modifications may be possible to the embodiment without departing from the gist of the invention:

In order to cut down the number of parts and improve assembling efficiency in the embodiment, the pivot shaft 16 for supporting the outside lever 17 is formed together with the body 5 of the engagement assembly 2, but the outside lever 17 may be supported with a separate pivot shaft.

In the embodiment, the outside lever 17 comprises two separate elements of the first lever 171 and second lever 172, but a single outside lever 17 may be provided.

In the embodiment, a plurality of guides which form positioning-guide means is provided on the second casing 402, but the guides may be provided on the first casing 401 or on both the first and second casings.

1. A vehicle door latch device comprising:
an engagement assembly that comprises an engagement mechanism which engages with a striker of a vehicle body to hold a door closed;
an operating assembly that comprises a first casing to which an operating mechanism which can turn the door to a locking state and an unlocking state is connected from a single direction, and a second casing disposed approximately perpendicular to the first casing, the engagement assembly being capable of being connected to the second casing;
a cover that covers the operating mechanism connected to the first casing from the single direction; and
positioning-guide means disposed on at least one of the first casing and the second casing, the positioning-guide means guiding the engagement assembly from the same direction as the single direction for connecting the operating mechanism to the first casing,
wherein after the engagement assembly is connected to the second casing, the operating mechanism connected to the first casing is covered with the cover, the cover preventing a side of the engagement assembly opposite the single direction from moving in an opposite direction to the single direction.

2. The vehicle door latch device of claim 1 wherein an outside lever which actuate the engagement mechanism so as to open the door is rotatably supported by the engagement assembly.

3. The vehicle door latch device of claim 1 wherein the positioning-guide means positions the second casing to prevent the engagement assembly from moving in a direction perpendicular to the single direction.

4. The vehicle door latch device of claim 1 wherein the engagement assembly comprises a back member on a back side, the positioning-guide means being provided on the back plate and the first casing or the second casing.

5. The vehicle door latch device of claim 1 wherein the engagement assembly comprises a body connected to the engagement mechanism, a
pivot shaft that supports the outside lever being provided on the body.
